(19) United States
(12) Patent Application Publication
(10) Pub. No.: US 2026/0279368 A1
(43) Pub. Date: Sep. 17, 2026

(54) AUDIO PROCESSOR FOR EXTENDED THE AUDIO BANDWIDTH OF BAND-LIMITED AUDIO SIGNAL

(71) Applicant: Fraunhofer-Gesellschaft zur Förderung der angewandten Forschung e.V., München (DE)

(72) Inventors: Guillaume FUCHS, Erlangen (DE); Martin MÜLLER, Erlangen (DE); Domenico TIZIANI, Erlangen (DE); Franz REUTELHUBER, Erlangen (DE); Sascha DISCH, Erlangen (DE); Sebastian BOLTEN, Erlangen (DE); Sanya TAYAL, Erlangen (DE)

(73) Assignee: Fraunhofer-Gesellschaft zur Förderung der angewandten Forschung e.V., München (DE)

(21) Appl. No.: 19/671,005

(22) Filed: May 7, 2026

Related U.S. Application Data
(63) Continuation of application No. PCT/EP2024/081757, filed on Nov. 8, 2024.

(30) Foreign Application Priority Data
Nov. 10, 2023 (EP) 23209170.2

(51) Int. Cl. G10L 19/06; G10L 19/02; G10L 19/26

(52) U.S. Cl. CPC G10L 19/06; G10L 19/02; G10L 19/26

(57) ABSTRACT

The audio processor for extending a band-limited audio signal, comprising:
an envelope determiner for determining a temporal envelope from a linear prediction residual of the band-limited audio signal or an excitation modelling the linear prediction residual of the band-limited audio signal;
an analyzer for analyzing the temporal envelope to determine certain values of the temporal envelope;
an excitation generator for generating an excitation, by placing pulses in relation to the determined certain values, wherein the pulses are weighted using weights derived from the temporal envelope;
an extended band generator generating an extended-band audio signal by processing the generated excitation;
a combiner combining the band-limited audio signal with the generated extended-band audio signal to obtain a frequency enhanced audio signal.

### CROSS-REFERENCE TO RELATED APPLICATIONS

This application is a continuation of copending International Application No. PCT/EP2024/081757, filed Nov. 8, 2024, which is incorporated herein by reference in its entirety, and additionally claims priority from European Application No. EP 23209170.2, filed Nov. 10, 2023, which is also incorporated herein by reference in its entirety.

Embodiments of the present invention refer to an audio processor using a bandwidth extension technique (BWE) called Waveform Envelope Synchronized Pulse Excitation (WESPE) and to a corresponding method and computer program. Embodiments refer to an audio processor of a band-limited audio signal, a decoder or an encoder comprising the WESPE audio processor. Embodiments refer to advanced and low complexity WESPE.

### BACKGROUND OF THE INVENTION

Bandwidth extension (BWE) is a technique used in speech coding to enhance the quality of speech transmission in situations where the available bandwidth or the possible bit-rate is limited. In essence, it is a method of expanding the frequency range of a speech core-coder, like Code-excited linear prediction (CELP), beyond the Nyquist frequency of its internal sampling rate, which can improve the perceived quality of the reconstructed speech signal at the decoder side. Usually, the bandwidth extension techniques in audio coding, transmit no, or very few additional parameters, and required therefore no or very limited extra bit-rate over the baseband coder.

Waveform Envelope Synchronized Pulse Excitation (WESPE) is an example of an efficient bandwidth extension, which can retain the original high-frequency (HF) fine structure, while being more controllable than the systematic copying, shifting, mirroring, or non-linear operations, usually used in this type of system. However, the procedure relies heavily on the extraction of a relevant time envelope, which proves to be a difficult task especially for low complexity systems.

Bandwidth extension is very well studied and established technique, already deployed in different existing standard like, HeAAC and 3GPP Enhanced Voice Services (EVS). It is usually built over a baseband coder, like a speech coder of type CELP or a generic transform-based audio coding, like MPEG-4 Advanced Audio Coding (AAC) or Transform Coded Excitation (TCX) used in MPED-D USAC or 3GPP EVS. In consequence, bandwidth extension can be performed either in time domain, or in frequency domain or in both domains. However, the great majority of the techniques dissociate the modelling of the frequency fine structure, called excitation in Time Domain, and coarse spectral structure, also called spectral envelope.

For great bit saving, the principle is based on generating the fine structured high frequency content from the transmitted low frequency content from the baseband coder. The high frequencies are then spectrally shaped and/or post processed before being mixed at the decoder side to the decoded baseband. The whole process can be steered by transmitted parameters.

The main problem is usually that HF content generated from LF may not fit original fine structure. It is particularly true if copy-up (like in Spectral Band Replication (SBR) of MPEG HeAAC) or mirroring (like in 3GPP AMR-WB+) of the LF content is used to generate the HF fine structure. Non-linearity (like in the Time-Domain-BWE of 3GPP EVS) operations are able to preserve some consistency in the harmonicity or during transients but turns out to be difficult to control and to steer.

On the other hand, WESPE is advantageous in that, in contrast to non-linearity processing, it provides a readily controlled procedure by placing pulses at maxima positions of an extracted time envelope. However, the extraction of a relevant temporal envelope is then essential and critical, especially in a system with hard constraints on complexity and algorithmic delay.

WESPE shows some complexity, and high constraints for an efficient implementation, more particularly for the time envelope extraction and its averaging and smoothing. The present invention proposes a new efficient way to extract the time envelope for the LF content and smooth it for extrema finding.

Therefore, there is a need for an improved approach.

### SUMMARY

According to an embodiment, an audio processor for extending the audio bandwidth of a band-limited audio signal may have: an envelope determiner for determining a temporal envelope from a linear prediction residual of the band-limited audio signal or an excitation modelling the linear prediction residual of the band-limited audio signal; wherein the envelope determiner includes a redressing entity configured to perform a redressing of the residual or the excitation signal to obtain a redressed residual signal or a redressed excitation signal; wherein the redressing is performed using resampling, or an absolute operation, or a power operation of a magnitude of the residual or excitation signal, or a processed version of the residual or excitation signal; an analyzer for analyzing the temporal envelope to determine certain values of the temporal envelope; wherein the analyzer is configured for determining temporal values of local maxima or local minima as the certain values; an excitation generator for generating an excitation, by placing pulses in relation to the determined certain values, wherein the pulses retained an amplitude of the time-domain envelope; wherein the pulses are weighted using weights derived from the temporal envelope; an extended band generator generating an extended-band audio signal by processing the generated excitation; a combiner combining the band-limited audio signal with the generated extended-band audio signal to obtain a frequency enhanced audio signal.

According to another embodiment, an audio decoder may have a baseband decoder for decoding a low-frequency band portion and a bandwidth extension decoder for decoding a high-frequency band portion, wherein the bandwidth extension decoder includes the inventive audio processor.

Another embodiment may have an audio encoder including a baseband encoder for encoding a low-frequency band portion and including or using the inventive audio processor.

According to another embodiment, a method for processing band-limited audio signal, may have the steps of: determining a temporal envelope from a linear prediction residual of the band-limited audio signal or an excitation modelling the linear prediction residual of the band-limited audio signal; wherein the determining includes a redressing of the residual or the excitation signal to obtain a redressed residual signal or a redressed excitation signal; wherein the redressing is performed using resampling, or an absolute operation, or a power operation of a magnitude of the residual or excitation signal, or a processed version of the residual or excitation signal; analyzing the temporal envelope to determine certain values of the temporal envelope; analyzing including determining temporal values of local maxima or local minima as the certain values; generating an excitation, by placing pulses in relation to the determined certain values, wherein the pulses retained an amplitude of the time-domain envelope; wherein the pulses are weighted using weights derived from the temporal envelope; generating an extended-band audio signal by processing the generated excitation; combining the band-limited audio signal with the generated extended-band audio signal to obtain a frequency enhanced audio signal.

Another embodiment may have a non-transitory digital storage medium having a computer program stored thereon to perform the inventive method for processing band-limited audio signal, when said computer program is run by a computer.

Embodiments of the present invention provide an audio processor for extended the audio bandwidth of a band-limited audio signal. The processor comprises an envelope determiner, an analyzer for analyzing the temporal envelope, an excitation generator, an extended band generator, and a combiner. The envelope determiner is configured for determining a temporal envelope from at least a portion of a linear prediction residual of the band-limited audio signal or an excitation modelling the linear prediction residual of the band-limited audio signal (signal, e.g. LPC residual/excitation signal of a low-band/baseband portion). The analyzer is configured for analyzing the temporal envelope to determine certain values of the temporal envelope. The excitation generator is configured for generating an excitation (e.g., by peak picking and/or downsampling), e.g. by placing pulses in relation to the determined certain values, wherein the pulses are weighted using weights derived from the temporal envelope. The extended band generator is configured for generating an extended-band audio signal by processing the generated excitation. The combiner combining the band-limited audio signal with the generated extended-band audio signal to obtain a frequency enhanced audio signal.

For example, the analyzer may be configured for determining the temporal values of local maxima or local minima as the certain features.

According to embodiments, the extractor comprises a redressing entity configured to perform a redressing of the residual or the excitation signal to obtain a redressed residual signal or a redressed excitation signal. For example, the extractor may comprise a smoothing entity configured to smooth the redressed residual signal or the redressed excitation signal to obtain the time domain envelope.

The extractor performed in this way can provide a new efficient way and can be enhanced to extract the time envelope for the LF content and smooth it for extrema finding. According to embodiments, the time domain envelope extraction (for WESPE) may comprise redressing a residual or processing the residual of at least one linear prediction together with smoothing the redressed signals by a low filter and/or a linear interpolation. This principle has the advantage of low complexity and high efficient time domain envelope extraction (for WESPE).

According to another embodiment, where the extractor comprises a smoothing entity configured to smooth the redressed residual signal or the redressed excitation signal, the smoothing entity may comprise a low filter or interpolator, especially a linear interpolator (for the smoothing to obtain the time domain envelope). These implementations are advantageous due to its low complexity.

According to another embodiment, the redressing may be performed using an absolute operation or a power operation of a magnitude of the excitation signal or residual signal, respectively. Alternatively or additionally, the redressing may be performed by resampling of the excitation signal or residual signal. The resampling is a high efficient operation so supports the overall aim of reducing the complexity and increasing the efficiency.

According to embodiments, the redressed receiver signal or a redressed excitation signal may be filtered in the time domain (TD) using a zero-phase filtering by processing the redressed excitation signal in both the forward and reverse directions, operation also called, filtfilt( ) function or, alternatively, using margins or guards and/or enforcing linear phase.

According to embodiments, the residual signal or the excitation signal is provided to the WESPE Coder by a baseband coder like coded-excitation linear predictive (CELP) or LPC-based coder or any baseband coder. This may, for example, be done by simple copy. For example, the residual signal or the excitation signal is provided as excitation of a (short-term) linear predictive synthesis filter, like LPC synthesis filter or computed from a decoded baseband coding after LPC analysis of the decoded signal and derivation of prediction coefficients. According to embodiments, the residual signal or the excitation signal is provided as a an excitation being or modelling the residual of a linear prediction, which can be achieved after a LPC analysis of the decoded signal. Note the extended-band audio signal may correspond to high frequency band audio signal which encompasses frequencies above the frequencies of band-limited audio signal.

Another embodiment provides a (WESPE) Coder which is configured to resample the excitation signal to obtain a resampling of the excitation signal, wherein the resampling may be performed by linear interpolation or polynomial fitting or TD filtering or FD filtering to obtain a resampling of the excitation signal.

By placing the pulses for generated band extended excitation, it is possible to perform a finding of a maxima of the extracted TD envelope. This can be done by peak picking. Any of the pulses are positioned at the maxima, wherein the rest of the vector are zeroed. For example, the pulses are retained on amplitude of the TD envelope.

According to further embodiments, the processor may comprise a downsampler configured to perform a downsampling on the extracted signal or generated thereof. Exemplarily, downsampling of the generated excitation may comprise a high-pass filtering. For example, the downsampling can be performed after redressing or the maxima finding so that only the HFs retain.

Another embodiment provides a decoder comprising a baseband decoder for decoding an LF portion and a BWE decoder for decoding an HF portion, wherein the bandwidth extension decoder comprises the WESPE Coder as discussed above. Another embodiment provides an encoder comprising or using the audio processor as discussed above. The two embodiments of the encoder and decoder are beneficial since, by use of the above-defined WESPE Coder, the essential and critical part of extraction of relevant temporal envelopes is solved by a concept with low complexity but high efficiency.

According to embodiments, the generated excitation (E) may be mixed to another excitation which is not derived from the temporal envelope (TDE). According to further embodiments, the generated excitation (E) may be mixed to a random noise or a gaussian noise.

Another embodiment provides a corresponding method which comprises a step of extracting a time domain envelope from a residual or an excitation signal (LPC receiver/excitation signal) of a low band portion.

According to embodiments, the method may comprise one of the following steps:
determining a temporal envelope (TDE) of at least a portion of a linear prediction residual of the band-limited audio signal (AS) or an excitation modelling the linear prediction residual of the band-limited audio signal (AS):
analyzing the temporal envelope (TDE) to determine certain values (V) of the temporal envelope (TDE);
generating an excitation (E), by placing pulses in relation to the determined certain values (V), wherein the pulses are weighted using weights derived from the temporal envelope (TDE);
generating an extended-band audio signal (EBAS) by processing the generated excitation (E);
a combiner (19) combining the band-limited audio signal (AS) with the generated extended-band audio signal (EBAS) to obtain a frequency enhanced audio signal (FEAS).

Another embodiment provides a corresponding computer program for a computer implemented method for performing method for coding a signal.

### BRIEF DESCRIPTION OF THE DRAWINGS

Embodiments of the present invention will be detailed subsequently referring to the appended drawings, in which:

FIG. 1 shows a block diagram of an audio processor according to a basic embodiment;

FIG. 2 shows a block diagram for a level zero of the split band encoder, involving the baseband encoder and the BWE encoder and according to further embodiments;

FIG. 3 shows a schematic illustration of dual band systems realized with block transforms, namely DFTs according to further embodiments;

FIG. 4 shows a schematic block diagram of a BWE encoder according to further embodiments;

FIG. 5 shows a schematic block diagram of a level zero of the split band decoder, involving the baseband decoder and the BWE decoder according to embodiments.

### DETAILED DESCRIPTION OF THE INVENTION

Below, embodiments of the present invention will subsequently be discussed referring to the enclosed figures, wherein identical reference numbers are provided to objects having identical or similar functions so that the description thereof is interchangeable and mutually applicable.

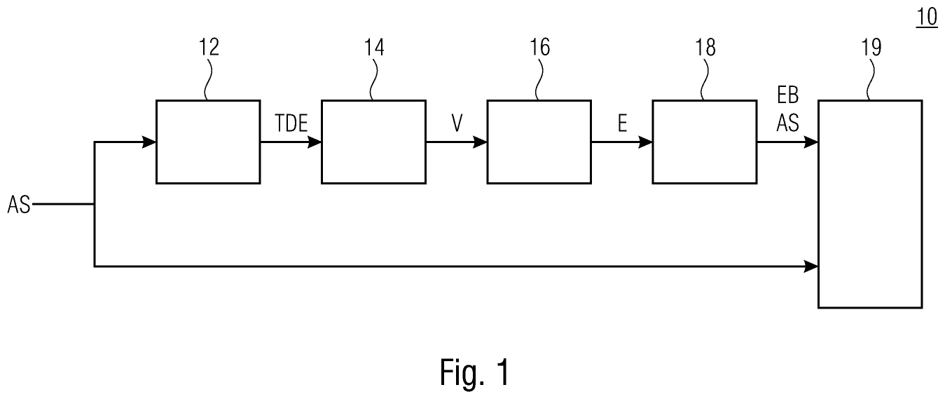

FIG. 1 shows an audio processor 10 comprising an envelope determiner 12, an analyzer 14 for analyzing the temporal envelope, an excitation generator 16, an extended band generator 18, and a combiner 19.

The audio processor 10 may be part of a coder by a WESPE coder or may use a WESPE codec. The audio processor receives a band-limited audio signal AS which may, for example, be low band portion or high band portion, i.e. a signal having limited bandwidth. For this audio signal AS, a temporal envelope is determined by use of the envelope determiner 12. The envelope determiner 12 is configured to determine the temporal envelope of at least a portion of a linear prediction residual of the band-limited audio signal AS or an excitation, modelling the linear prediction residual of the band-limited audio signal. For example, an excitation signal may be an excitation of a short term linear predictive filter (like LPC) or can alternatively be computed from a decoded baseband coding after LPC analysis, which may consists of computing an short-term autocorrelation function from the decoded signal, applying a Levinson-Durbin recursion to obtain the optimal prediction coefficients before computing the residual of the so-obtained prediction.

The envelope determiner 12 outputs the time domain envelope TDE. The envelope determiner 12 may, for example, perform the extraction of a time domain envelope TDE. This may, for example, be done by resampling and/or redressing, and/or smoothing. The result is an envelope in a time domain, which is then further exploiting to find maxima to position pulses in order to generate a HB signal and or excitation

After that, the analyzer 14 performs the analysis of the temporal envelope TDE, so as to determine certain values V, e.g. a minima, maxima, local minima, etc. of the temporal envelope TDE. After the analysis, the excitation generator 16 generates an excitation signal based on the determined values and the temporal envelope. For this, the excitation signal generator 16 may be configured for generating the excitation E by placing pulses in relation to the determined certain values, where the pulses are weighted using weights derived from the temporal envelope TDE. This generator excitation signal E is then used for extending the band.

The extended band generator 18 is configured to generate an extended-band audio signal EBAS by processing the generated excitation E. The extended-band audio signal can be derived by applying high-pass filtering and/or downsampling and/or LPC synthesis filtering and/or gain or energy adjustment Output is the extended band audio signal which is output to the combiner 19. The combiner 19 combines the signal EBAS with the band-limited audio signal AS to obtain a frequency enhanced audio signal EBAS. The combiner could work either in time domain involving upsampling filters or in frequency domain after a time-domain decomposition like a filter-band or a block transform like a DFT.

According to embodiments, temporal values of maxima or local maxima or minima or local minima are used as the certain values V.

According to enhance embodiments, the extractor 12 receives the excitation of a short-term linear prediction filter or a residual R, e.g., from a baseband decoder. The excitation signal or residual signal may be redressed by use of a redressing entity. The redressing may be, for example, performed using an absolute operation or a power operation of the magnitude of the excitation signal/residual signal. Alternatively, a resampling of the excitation signal or residual signal may be used.

According to embodiments, the excitation signal may be resampled to a target sampling rate, where the WESE is applied. For a specific case, WESPE is performed at 32 KHz, wherein of the baseband coder CELP runs at 16 kHz or at 12.8 kHz of sampling rate. Resampling can be performed by linear interpolation or polynomial fitting or TD filtering or FD filtering. It can be also performed by simple decimation, discarding some samples and/or adding new samples.

The redressed excitation signal or redressed residual signal can, according to embodiments, be smoothed using the smoothing entity to obtain the time domain envelope. For example, the smoothing entity may comprise a low filter or interpolator or especially linear interpolator. According to further embodiments, the residual or excitation signal may be filtered in the time domain using a zero-phase filtering also known as a zero-phase filter or a linear filter or filtfilt( ) function and/or using margins or guards overlapping with the adjacent processing frames for obtaining a smooth envelope even at the frame borders.

Note the band-limited audio signal may be a decoded signal from a baseband coder.

According to embodiments, the result of this step or the result of the extracting step (with or without redressing and/or smoothing) may be an obtained high band portion (HBP). The obtaining may be performed based on the extracted time domain envelope, e.g., by peak picking and/or down sampling. Here, pulses are positioned at the maxima, the rest of the vector are zeroed. Pulses retain the amplitude of the TD envelope. According to embodiments the audio processor may be configured to obtain the extended-band signal based on the extracted time domain envelope or based on the extracted time domain envelope by peak picking and/or downsampling.

According to further embodiments, the obtained WESPE excitation is downsampled, e.g., to 16 kHz (cf. above) retaining only the HFs. The 16 KHz is just an example since the CELP coder is running at 16 kHz, which leads to double the audio bandwidth in this case. Of course, the down sampling may be performed to a different frequency.

It should be noted that, according to embodiments, the extractor may comprise just the redressing entity or just the smoothing entity or may just perform the step of obtaining the high band portion HBP, wherein, according to embodiments, the three entities are collaborating together so as to obtain the HB excitation.

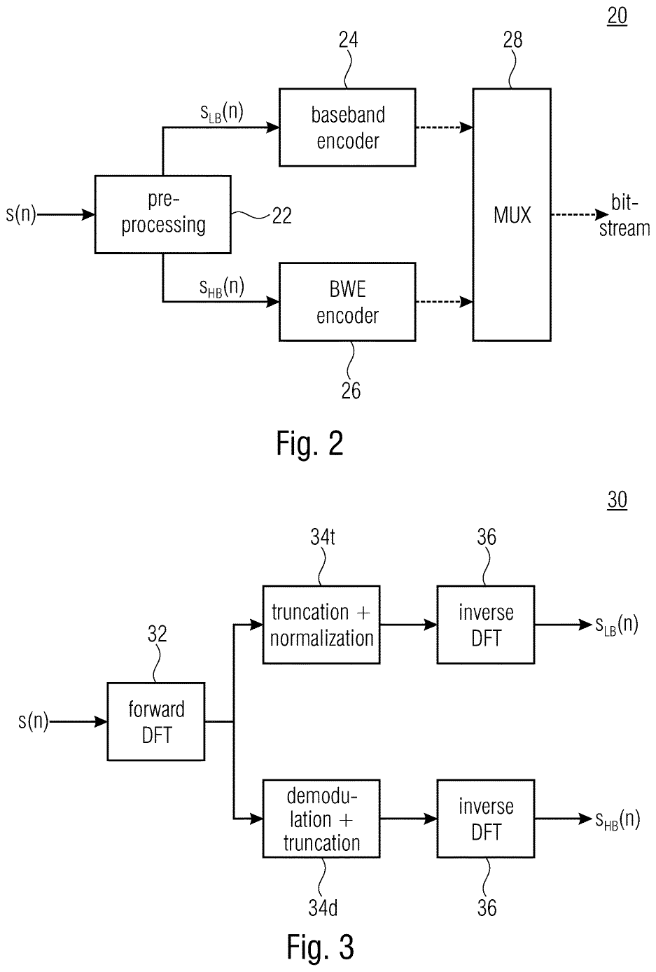

With respect to FIGS. 2 to 5 applications of the above discussed WESPE Coder enabling the bandwidth extension.

FIG. 2 shows an encoder 20, a pre-processor 22, a baseband encoder 24 and a parallel BWE encoder 26.

The input signal is first conveyed to pre-processing block 22, which is in charge of converting of doing several analyses like a pitch estimation, a voice activity detection but also to convey signals sampling rate at a proper sampling rate to the subsequent coding modules, consisting in our case to baseband coder 24 and bandwidth extension 26. For this a filter-bank, like a QMF, pseudo QMF, modulated lapped or block transforms, or simply downsampling multi-band filters in time domain can be used. The signals of the baseband coder 24 and bandwidth extension 26 are combined by the multiplexer 19. The audio processor may be part of the bandwidth extension 26. This means that the bandwidth extension 26 is implemented by or comprises the audio processor 10 as discussed in context of FIG. 1. Expressed in other words, this means that the entity 26 includes all of the sub-entities 12, 14, 16 and 18, i.e., the entity 26 outputs the EB AS signal to the multiplexer 19 which combines this signal with the baseband-coded signal 24. According to further embodiments, the processor 10 comprises an own multiplexer which combines EB AS with AS and forwards a combined signal to the multiplexer 19 as shown by FIG. 2. The multiplexer 19 outputs the bitstream as illustrated by FIG. 2.

The two signals conveyed to the baseband encoder 24 and the bandwidth extension (BWE) encoder 26 are usually at sampling rates lower than the sampling rate of the input signal s(n). The low band signal S_{lb}(n) is composed of frequencies below a cross-over frequency which is usually the corresponding Nyquist frequency of its sampling-rate. On the other hand, the high band signal S_{hb}(n) is composed of frequencies above a cross-over frequency which is usually the corresponding Nyquist frequency of its sampling-rate. The HB and LB cross-over frequencies are usually the same. Therefore, and in the usual case, the two signals are complementary in frequency representation of the input signal and at the same time the whole multi-rate system is critically sampled. As an example, S_{lb}(n) and S_{hb}(n) are both sampled at 16 kHz, S_{lb}(n) retaining frequencies from 0 to 8 kHz, and S_{hb}(n) retaining frequencies from 8 to 16 kHz. Another alternative is to have S_{lb}(n) sampled at 12.8 kHz, composed of frequencies from 0 to 6.4 kHz and S_{hb}(n) sampled at 16 kHz composed of frequencies from 6.4 to 14.4 kHz. As in the filter-bank convention and in the subsequent description, the high-band signal (odd indexed band), is frequency reversed.

The low-band signal is conveyed to the baseband coder, which in our preferred case is a CELP-based speech coding system, as in AMR-WB or 3GPP EVS. The S_{lb}(n) signal advantageously contains a broadband signal sampled at 12.8 or 16 kHz.

FIG. 3 shows a schematic block diagram of a two-band system realized with block transforms, for example DFTs. The two-band system comprises the forward DFT 32 and two parallel DFT branch. The one DFT branch comprises truncation and normalization entity 34t and an inverse DFT 36, while the other string comprises a demodulator and truncation entity 34d and also an inverse DFT 36. The first string 34t plus 36 is used for the low band while the second string 34d plus 36 for the high band.

The truncation and normalization 34t of DFT spectrum serves as lowpass filtering and the Inverse DFT 36 is operating at a size corresponding to the target sampling rate for the low-band signal. For the high band, only the high frequencies are retained and copied and flipped to the baseband (aka known as demodulation, cf. 34d) before being decimated by the Inverse DFT 36 with a size corresponding to the sampling-rate of high-band signal.

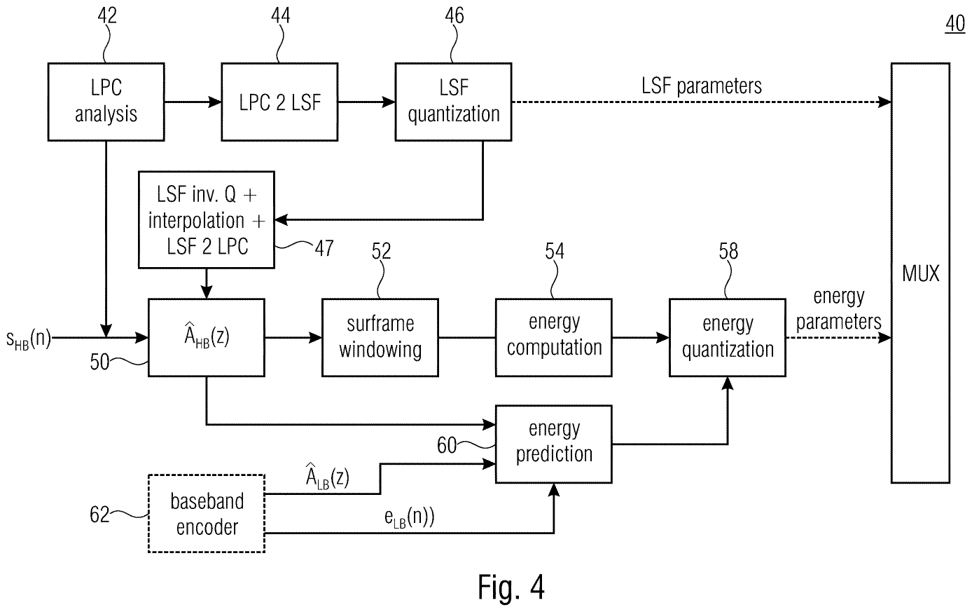

FIG. 4 illustrates a BWE encoder 40 comprising LPC analysis 42, LPC 2 LSF 44 and LSF quantization 46 enabling to output LSF parameters.

In parallel to a calculation of the LSF parameters, energy parameters are determined using the entities 50, 52 (subframe windowing), 54 (energy computation) and 56 (energy quantization). The energy quantization 56 is based on the energy computation 54 and the energy prediction 60 which gets the signal from the entity 50 and from a baseband coder 62. The entity 50 is connected with the input for the signal and the LSF quantization 46, via the entity 47.

The BWE encoder 40 receives the high-band signal S_{hb}(n) in order to extract the main salient parameters from it, namely its spectral shape and its energy. To do this, it follows a source-filter model like in CELP coding scheme and exploits the Linear Predictive Coding (LPC). LPC 42 and 44 is an adaptive filter that models the short-term linear prediction and, through duality between time and frequency domains, the spectral envelope of the signal. Quasi-optimality of LPC holds for near stationary segments, which for audio and speech signal can be considered for a duration of about 20 ms. Therefore, the signal is partitioned into 20 ms frames, and the LPC analysis 42 and parameter computation are performed at frame basis. For smoothing the transition, the LPC coefficients are further interpolated between adjacent frames, at a subframe level of duration 4 or 5 ms. The interpolation is performed by linear interpolation of line spectral frequencies (LSFs, cf 44 and 46) used to represent linear prediction coefficients (LPC). LSFs have several interesting properties, like a smaller sensitivity to quantization noise, that make them superior to direct quantization of LPCs.

An LPC analysis 42 aka short-term linear analysis is performed on S_{hb}(n) to obtain a set of LPC coefficients. Since speech and in general audio shows less structure or formant structure in the high frequencies, fewer parameters are required than for the low-band signal. In our preferred mode, an order of 8 or 10 is used for a 16 kHz sampled S_{hb}(n) signal.

The LPC analysis is performed as it can be done in baseband encoder, that means, by windowing the signal, computing the autocorrelation function up to a maximum lag corresponding to the order, before finding the optimal prediction coefficients with a recursive algorithm like Levinson-Durbin. It is worth noting that the LPC analysis windows of both low and high band can be the same and advantageously time aligned, which will be an advantage in the subsequent processing steps, but also for exploiting the same lookahead.

The so-obtained LPC coefficients or their LSF representation are then quantized and coded. Once again since the spectral envelope of the high-band is usually less structured and also perceptually less relevant, quantization resolution can be lowered for the BWE coding compared to the baseband coding. For the quantization and the coding, a Vector quantization or a multi-stage vector quantization is advantageously applied after conversion of LPC coefficients to LSFs. Precomputed LSF means, obtained during an offline analysis on a dataset, is removed before quantization as well as a 1st order prediction obtained from the previously transmitted set of LSFs. The LSF residual are then vector quantized using from 8 to 16 bits per frame in an embodiment. The quantized LSFs are converted to quantized LPC coefficients to form the LPC analysis filter Â_{HB}(z) used to whiten the high-band signal and obtain the residual signal e_{HB}(n):

$${e}_{HB} ( n ) = {s}_{HB} ( n ) - {\sum }_{i = 1}^{{M}_{HB}} {a}_{i} {s}_{HB} ( n - i ) , \qquad n = 0 , … , {L}_{sub} - 1$$

where M_{HB} is the LPC order, and L_{sub}, the size of the subframe for which the LPC coefficients are constant (Lsub=80 samples for 5 ms subframe at 16 kHz).

The energy of e_{HB}(n) is then computed (cf. 54) and coded per sub-frame of 4 to 5 ms (5 ms in our preferred mode) using rectangular and non-overlapping windows (cf. 52). This way, an energy parameter can be transmitted at every 4 to 5 ms.

In order to save transmitted bits, the energy is not coded and quantized directly, but after a prediction exploiting the information derived from the low band. Only the residue of the energy prediction is then quantized. This information may be shared with the decoder, since the inverse prediction may be performed on the decoder side. For this purpose, if the baseband code is CELP-based, as in a preferred mode, the A_{LB}(z) low-band LPC analysis filter can be reused, using the quantized and transmitted LPC coefficients, as well as the coded excitation. Analysis of these two components, especially in the high frequencies of the low band, around the Nyquist frequency, gives a robust estimate of the high-band energy and the residual of the high-band LPC analysis. For a 20 ms framing, a set of 4 energy parameters are then obtained, and can be coded for example with a vector quantization using 7 bits. For even lower bit demand, the energy can be averaged (geometrically in the preferred mode) over the frame size for the 4 subframes, to obtain 1 single value per frame to transmit. A 4 bit quantization is then enough. In the extreme case, only the estimate can used at the decoder without additional guidance from the encoder, corresponding then to a Obit quantization.

Possible BWE parameters and bit allocations are

| | Resolution | Bits | Bit-rate (kbps) |
|---|---|---|---|
| LSF parameters | 20 ms | 0/8/8/8/16 | 0/0.4/0.4/0.4/0.8 |
| Energy parameters | 5/20 ms | 0/0/4/7/7 | 0/0/0.2/0.35/0.35 |
| Total | | 0/8/12/15/23 | 0/0.4/0.6/0.75/1.15 |

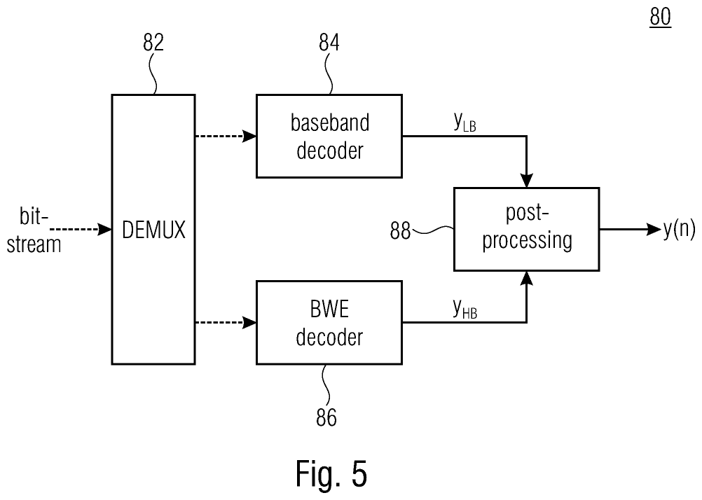

With respect to FIG. 5, a BWE decoder will be discussed. It comprises the demultiplexer 82, a baseband decoder 84 and a BWE decoder 86. Furthermore, the two decoded signals y_{lb} and y_{hb} are combined by the pre-processor 88 so as to obtain the signal y (n).

From the transmitted parameters, i.e. the coded LPC coefficients and coded energies, an artificially generated excitation is energy normalized and scaled, and then spectrally shaped by the synthesis LPC filter 1/Â_{HB}(z).

The generated y_{HB}(n) signal is then combined to the decoded low-band signal y_{LB}(n) to form the reconstructed signal y(n), as it is shown in FIG. 5, reference number 88. It can be achieved using a filter-bank, block transforms or time-domain up-sampling. In the embodiment, a complex-valued low-delay filter bank (CLDFB) as described in 3GPP EVS, is used, which allows to perform additional post-processing steps in the filter-bank domain before combining the two components and transforming the signal back to the time-domain and at the desired sampling rate.

Below, the embodiment for excitation generation will be discussed.

HB excitation is usually generated artificially, in the sense that little or no parameters are transmitted for it. To generate a suitable excitation, the decoded low-band signal is used intensively. In the example, where LB excitation is already available in CELP, it could be as simple as copying coded LB excitation for generating the HB excitation, if both signals are at the same sampling rate. This then corresponds to a mirroring replication in the frequency domain, since the high-band signal is frequency inverted in our case.

This leads to decent quality, but also to some obvious problems: harmonicity is often overestimated, and generated harmonics in the high-band do not necessarily correspond to the natural subharmonics of the fundamental frequency. It is also possible to apply a non-linear operation by increasing the excitation and applying a non-linear operation, then sub-sampling the component at high frequency. This approach is the one adopted in 3GPP EVS in the Time-Domain BWE. In our preferred version, the method known as WESPE is adopted, giving greater control over the final result and the amount of harmonicity injected. WESPE is adopted in the invention to work in the above-described framework, i.e. the LPC residual domain and also applied over the code excitation of CELP. The pseudo-code below gives the main steps.

Some of the above steps may be software implemented. The software may be defined by a source code or pseudo code. An example is shown below.

```
// 1.and 2. Get the LB excitation from CELP, and resampled it at 32kHz
  if ( st−>L_frame == L_FRAME ) // from 12.8 kHz to 32kHz
  {
    lerp( excLb, excLb_16k, L_FRAME16k, L_FRAME ); // linear interpolation for zero-delay resampling of
LB excitation
    Interpolate ( exclb_16k, hBwe−>wespe_exc_inter16_32k, L_FRAME16k, t_wespe_guarded + 2 *
CELP_BWE_GUARDSIZE );
  }
  else // from 16 kHz to 32kHz
  {
    Interpolate( excLb, hBwe−>wespe_exc_inter16_32k, L_FRAME16k, t_wespe_guarded + 2 *
CELP_BWE_GUARDSIZE );
  }
  // Buffer manager for LB excitation
  mvr2r( hBwe−>mem_wespe_excLB, t_wespe_guarded, 2 * CELP_BWE_GUARDSIZE );
  mvr2r( t_wespe_guarded + L_FRAME32k, hBwe−>mem_wespe_excLB, 2 * CELP_BWE_GUARDSIZE );
  // 3. Redress signal, used for wespe part, including guards left and right
  for ( int32_t i = 0; i < L_FRAME32k + 2 * CELP_BWE_GUARDSIZE; i++ )
  {
    t_wespe_guarded[i] = fabsf( t_wespe_guarded[i] );
  }
  // 4. Get time envelope by filtering (filt−filt = linear phase)
  dec_celpbwe_wespe_filtFilt( t_wespe_guarded, L_FRAME32k + 2 * CELP_BWE_GUARDSIZE, wespe_a_lp,
wespe_b_lp, env_guarded );
  // 5. Simple peak picking = wespe + random noise generation for the rest
  float wespe[L_FRAME_32k];
  float *avg_env = env_guarded + CELP_BWE_GUARDSIZE;
  for ( int32_t i = 0; i < L_FRAME32k; i++ )
  {
    wespe[i] = ( avg_env[i] > avg_el−[i − 1] && avg_env[i] > avg_Inv[i + 1] ) ? 1.f : 0.f;
    wespe[i] *= env[i];
  }
  // 6. flip and decimate to 16kHz
  for ( int32_t i = 0; i < L_FRAME32k; i += 2 )
  {
    wespe[i] = −wespe[i];
  }
  Decimate( wespe, hBwe−>wespe_exc_decim32_16k, L_FRAME32k, excHb );
```

According to embodiments, other features may be combined with above aspect aiming at providing a low-complexity and efficient time envelope extraction and artificially excitation generation procedure. The coder may comprise a baseband coder configured to code a low band signal of the signal; and a BWE coder configured to code a high band signal of the signal, the high band signal comprising a mixture of a first HF excitation and second HF excitation; wherein the BWE coder comprises a WEPE coder configured to generate the first HF excitation and a noise generator configured to generate random noise as the second HF excitation; wherein the mixture is controlled via a steering factor derived from a characteristics output by the baseband coder.

Additionally or alternatively, the coder may be part of an encoder for coding a signal comprising a LF signal and a HF signal, the encoder comprising: a calculator configured to perform energy prediction of the HF signal based on LPC coefficients; and a coder configured to encode a residual of the signal using the energy prediction and an offset; wherein the offset is dependent on a bit-rate.

Although since embodiments of the present invention have mainly been discussed in context of an apparatus, the method may also be computer implemented. The main steps have been discussed above. According to an embodiment, the method may comprise the following steps:
1. Get the excitation of a short-term linear predictive filter (like LPC) from a baseline code like CELP, by simple copy. [Alternatively, an excitation signal can be computed from a decoded baseband coding after LPC analysis].
2. Resample the excitation to the target sampling rate, where the WESPE is applied. For example and in our specific case, WESPE is performed at 32 kHz, a sampling rate at least twice the sampling rate of the baseband coder CELP running at 16 kHz or at 12.8 kHz. Resampling can be performed by linear interpolation/polynomial fitting and/or TD filtering and/or FD filtering.
3. The resampled excitation is redressed, using the absolute operation, or alternatively a power operation of the magnitude of the resampled excitation.
4. The redressed resample excitation is filtered in TD using a linear phase filtering or a zero-phase filtering, aka filtfilt( ) function, using optionally margins/guards for guarantying a smooth extracted envelope at the frame borders.
5. The maxima of the exctracted TD envelope are found, for example by simple peak picking.
   Pulses are positioned at the maxima, and the rest of the vector are zeroed. Pulses retained the amplitude of the TD envelope.
6. The so generated excitation can be mixed with randomly generated noise with a given mixing factor derived for example from the baseband decoding.
The so-obtained wespe excitation is down-sampled to 16 kHz, retaining only the 7. HFs.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, some one or more of the most important method steps may be executed by such an apparatus.

The inventive encoded audio signal can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. An audio processor for extending the audio bandwidth of a band-limited audio signal comprising:
an envelope determiner for determining a temporal envelope from a linear prediction residual of the band-limited audio signal or an excitation modelling the linear prediction residual of the band-limited audio signal; wherein the envelope determiner comprises a redressing entity configured to perform a redressing of the residual or the excitation signal to acquire a redressed residual signal or a redressed excitation signal; wherein the redressing is performed using resampling, or an absolute operation, or a power operation of a magnitude of the residual or excitation signal, or a processed version of the residual or excitation signal;
an analyzer for analyzing the temporal envelope to determine certain values of the temporal envelope; wherein the analyzer is configured for determining temporal values of local maxima or local minima as the certain values;
an excitation generator for generating an excitation, by placing pulses in relation to the determined certain values, wherein the pulses retained an amplitude of the time-domain envelope; wherein the pulses are weighted using weights derived from the temporal envelope;
an extended band generator generating an extended-band audio signal by processing the generated excitation;
a combiner combining the band-limited audio signal with the generated extended-band audio signal to acquire a frequency enhanced audio signal.

2. The audio processor coder according to claim 1, wherein the analyzer is configured for determining temporal values from the time envelope; and/or
wherein the analyzer is configured for peak picking and/or downsampling.

3. The audio processor according to claim 1, wherein the extended band generator is configured to use a linear predictive synthesis filter or a LPC synthesis filter with the generated excitation; for acquiring the extended-band audio signal.

4. The audio processor according to claim 1, wherein the extended-band audio signal corresponds to high frequency band audio signal which encompasses frequencies above the frequencies of band-limited audio signal.

5. The audio processor according to claim 1,
wherein the envelope determiner comprises a smoothing entity configured to smooth the redressed residual signal or the redressed excitation signal to acquire the time domain envelope.

6. The audio processor according to claim 5, wherein the smoothing entity comprises a low-pass filter or interpolator, especially linear interpolator.

7. The audio processor according to claim 5, wherein the redressed residual signal or a redressed excitation signal is filtered in time domain using a zero-phase filter or a linear filter or using margins or guards overlapping with the adjacent processed frames.

8. The audio processor according to claim 1, wherein the band-limited audio signal is a decoded signal from a baseband coder.

9. The audio processor according claim 8, wherein the residual signal or the excitation signal is provided to the audio processor by a baseband coder like coded-excitation linear predictive or LPC-based coder or any baseband audio or speech coder.

10. The audio processor according to claim 8, wherein the residual signal or the excitation signal of the band-limited audio signal is provided by performing a linear prediction or a LPC analysis of the decoded band-limited audio signal.

11. The audio processor according to claim 1, wherein the audio processor is configured to resample the excitation signal derived from the band-limited audio signal to acquire a resampling of the excitation signal, or wherein the audio processor is configured to resample the excitation signal by linear interpolation or polynomial fitting or time-domain filtering or frequency-domain filtering to acquire a resampling of the residual signal or excitation signal.

12. The audio processor according to claim 1, further comprising finding local maxima of the time domain envelope or peak picking to find local maxima of the time domain envelope.

13. The audio processor according to claim 12, wherein pulses are positioned at the maxima, and the rest of a vector are zeroed.

14. The audio processor according to claim 1, further comprising a downsampler configured for downsampling the generated excitation or a derivative thereof.

15. The audio processor according to claim 14, wherein the downsampling of the generated excitation comprises a high-pass filtering.

16. The audio processor according to claim 1, wherein the generated excitation is mixed to another excitation which is not derived from the temporal envelope.

17. The audio processor according to claim 1, wherein the generated excitation is mixed to a random noise or a gaussian noise.

18. An audio decoder comprising a baseband decoder for decoding a low-frequency band portion and a bandwidth extension decoder for decoding a high-frequency band portion, wherein the bandwidth extension decoder comprises the audio processor according to claim 1.

19. An audio encoder comprising a baseband encoder for encoding a low-frequency band portion and comprising or using the audio processor according to claim 1.

20. Method for processing band-limited audio signal, comprising the steps:
determining a temporal envelope from a linear prediction residual of the band-limited audio signal or an excitation modelling the linear prediction residual of the band-limited audio signal; wherein the determining comprises a redressing of the residual or the excitation signal to acquire a redressed residual signal or a redressed excitation signal; wherein the redressing is performed using resampling, or an absolute operation, or a power operation of a magnitude of the residual or excitation signal, or a processed version of the residual or excitation signal; analyzing the temporal envelope to determine certain values of the temporal envelope; analyzing comprising determining temporal values of local maxima or local minima as the certain values;
generating an excitation, by placing pulses in relation to the determined certain values, wherein the pulses retained an amplitude of the time-domain envelope; wherein the pulses are weighted using weights derived from the temporal envelope;
generating an extended-band audio signal by processing the generated excitation;
combining the band-limited audio signal with the generated extended-band audio signal to acquire a frequency enhanced audio signal.

21. A non-transitory digital storage medium having a computer program stored thereon to perform the method for processing band-limited audio signal, comprising the steps:
determining a temporal envelope from a linear prediction residual of the band-limited audio signal or an excitation modelling the linear prediction residual of the band-limited audio signal; wherein the determining comprises a redressing of the residual or the excitation signal to acquire a redressed residual signal or a redressed excitation signal; wherein the redressing is performed using resampling, or an absolute operation, or a power operation of a magnitude of the residual or excitation signal, or a processed version of the residual or excitation signal; analyzing the temporal envelope to determine certain values of the temporal envelope; analyzing comprising determining temporal values of local maxima or local minima as the certain values;
generating an excitation, by placing pulses in relation to the determined certain values, wherein the pulses retained an amplitude of the time-domain envelope; wherein the pulses are weighted using weights derived from the temporal envelope;
generating an extended-band audio signal by processing the generated excitation;
combining the band-limited audio signal with the generated extended-band audio signal to acquire a frequency enhanced audio signal,
when said computer program is run by a computer.
